(19) United States
(12) Patent Application Publication
(10) Pub. No.: US 2025/0083298 A1
(43) Pub. Date: Mar. 13, 2025

(54) TOOL ACCESSORY HOLDER, TOOL SYSTEM, AND TOOL ACCESSORY STORAGE SYSTEM

(71) Applicant: MILWAUKEE ELECTRIC TOOL CORPORATION, Brookfield, WI (US)

(72) Inventors: Evan H. Fischer, Milwaukee, WI (US); Zach M. McMahon, Wauwatosa, WI (US); Brad Urban, Wauwatosa, WI (US); Yi He Zeng, Ji'an City (CN)

(21) Appl. No.: 18/580,705

(22) PCT Filed: Jul. 19, 2022
(86) PCT No.: PCT/US22/37623

§ 371 Date: Jan. 19, 2024

(30) Foreign Application Priority Data
Jul. 22, 2021 (CN) 202121680283.0

(51) Int. Cl. B25H 3/00; B25H 3/02

(52) U.S. Cl. CPC B25H 3/003; B25H 3/021

(57) ABSTRACT

A tool accessory holder for use with a tool accessory case and configured to couple to a power tool, a tool system, and tool accessory storage system. The tool accessory holder can be removed from the tool accessory case and coupled to the power tool and removed from the power tool and coupled to the tool accessory case. The tool system includes an accessory holder and a power tool. The tool accessory holder is alternately couplable to the tool accessory storage case and to the power tool.

### TECHNICAL FIELD

The present disclosure relates to tool accessory holders, tool systems, and tool accessory storage systems. The present disclosure also relates to storage devices and, more particularly, to holders for tool bits.

### BACKGROUND

Holders for tool accessories or tool bits such as drill bits, impact screwdriver bits, torque bits, and the like are known. Such holders typically include retaining means for holding the tool bits in an organized manner. Conventionally, such holders are retained in storage cases configured to hold multiple tool accessory holders. In some instances, a user may require a variety of different tool bits useable with one or more power tools.

### SUMMARY

In first aspect, the disclosure provides a tool accessory holder for use with a tool accessory case and configured to couple to a power tool. The tool accessory holder includes a body configured to hold one or more tool accessories for use with the power tool. The body is selectively received in the tool accessory case. The tool accessory holder further includes a first retainer coupled to the body and configured to couple the tool accessory holder to the tool accessory case, and a second retainer coupled to the body and configured to couple the tool accessory holder to the power tool. The tool accessory holder can be removed from the tool accessory case and coupled to the power tool. The tool accessory holder is removable from the power tool and couplable to the tool accessory case.

In some embodiments of the first aspect, the first retainer is a projection extending from a side of the body.

In some embodiments of the first aspect, the projection is configured to be releasably coupled to an engagement feature located on a sidewall of the tool accessory case.

In some embodiments of the first aspect, the projection is a first projection. The first retainer also includes a second projection extending from a side of the body opposite the first projection.

In some embodiments of the first aspect, the second retainer is a bore formed in the body. The bore receives a threaded fastener to couple the tool accessory holder to the power tool.

In some embodiments of the first aspect, the bore extends through a front and a back of the body.

In some embodiments of the first aspect, the tool accessory holder is rotatable relative to tool accessory case while coupled to the tool accessory case.

In some embodiments of the first aspect, the tool accessory holder is moveable relative the tool accessory case between a storage position and an upright position while coupled to the tool accessory case.

In some embodiments of the first aspect, the body defines a plurality of compartments. Each of the plurality of compartments is configured to receive one of the one or more tool accessories for use with the power tool.

In some embodiments of the first aspect, the plurality of compartments is arranged in a row along a length of the body.

In some embodiments of the first aspect, the one or more tool accessories for use with the power tool include one or more selected from a group consisting of a drill bit, a driver bit, an impact bit, and a socket bit.

In a second aspect, the disclosure provides a tool system that includes a tool accessory storage case, a power tool, and a tool accessory holder configured to hold at least one tool accessory for use with the power tool. The tool accessory storage case includes one or more housing members at least partially defining a storage area, and an engagement feature located on the one or more housing members adjacent the storage area. The power tool includes a housing, a motor positioned in the housing, a drive assembly supported by the housing and coupled to the motor, and an output element coupled to the drive assembly. The tool accessory holder is alternately couplable to the tool accessory storage case and to the power tool.

In some embodiments of the second aspect, the tool accessory holder includes a first retainer couplable with the engagement feature of the tool accessory storage case. The tool accessory holder includes a second retainer couplable with a retainer of the power tool.

In some embodiments of the second aspect, the first retainer is a projection. The second retainer is a bore that receives a threaded fastener.

In some embodiments of the second aspect, the housing of the power tool includes a battery receptacle defining a foot of the power tool. The tool accessory holder couples to the foot.

In some embodiments of the second aspect, the housing also includes a motor housing portion that receives the motor and a handle portion extending from the motor housing portion. The battery receptacle is coupled to an end of the handle portion opposite from the motor housing portion.

In some embodiments of the second aspect, the engagement feature is one of a plurality of engagement features located on the one or more housing members. The tool accessory holder is couplable to the plurality of engagement features in different positions.

In a third aspect, the disclosure provides a tool accessory storage system that includes a tool accessory case including one or more housing members at least partially defining a storage area, and an engagement feature located on the one or more housing members adjacent the storage area. The tool accessory storage system further includes a tool accessory holder including a body configured to hold one or more tool accessories for use with a power tool, and a retainer coupled to the body. The retainer is selectively engageable with the engagement feature to removably couple the tool accessory holder to the tool accessory case. The tool accessory holder is removable from the tool accessory case and configured to couple to the power tool.

In some embodiments of the third aspect, the retainer is a projection extending from a side of the body. The engagement feature is a receiver formed in a sidewall of the one or more housing members.

In some embodiments of the third aspect, the tool accessory holder also includes a bore formed in the body. The bore receives a threaded fastener to couple the tool accessory holder to the power tool.

In a fourth aspect, there is provided a method of alternately coupling a tool accessory holder to a tool accessory case and a power tool. The method includes providing engagement features on the tool accessory case and coupling a retainer to a body of the tool accessory holder. The method further includes removably coupling the engagement features with the retainer to couple the tool accessory holder to the tool accessory case. The method even further includes removably coupling the tool accessory holder to the power tool.

Other aspects of the disclosure will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

FIG. 1 is a perspective view of a tool accessory case and a plurality of different tool accessory holders supported by the tool accessory case, according to one embodiment of the disclosure.

FIG. 2 is an exploded perspective view of the tool accessory case and the plurality of different tool accessory holders of FIG. 1.

FIG. 3 is a front perspective view of one of the tool accessory holders of FIG. 1.

FIG. 4 is a rear perspective view of the tool accessory holder of FIG. 3.

FIG. 5 is a perspective view of a power tool and the tool accessory holder of FIG. 3, illustrating the tool accessory holder separated from the power tool.

FIG. 6 is an enlarged perspective view of a foot of the power tool of FIG. 5 and the tool accessory holder of FIG. 3 coupled to the power tool.

FIG. 7 is an enlarged side view of the foot of the power tool of FIG. 5 and the tool accessory holder of FIG. 3.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

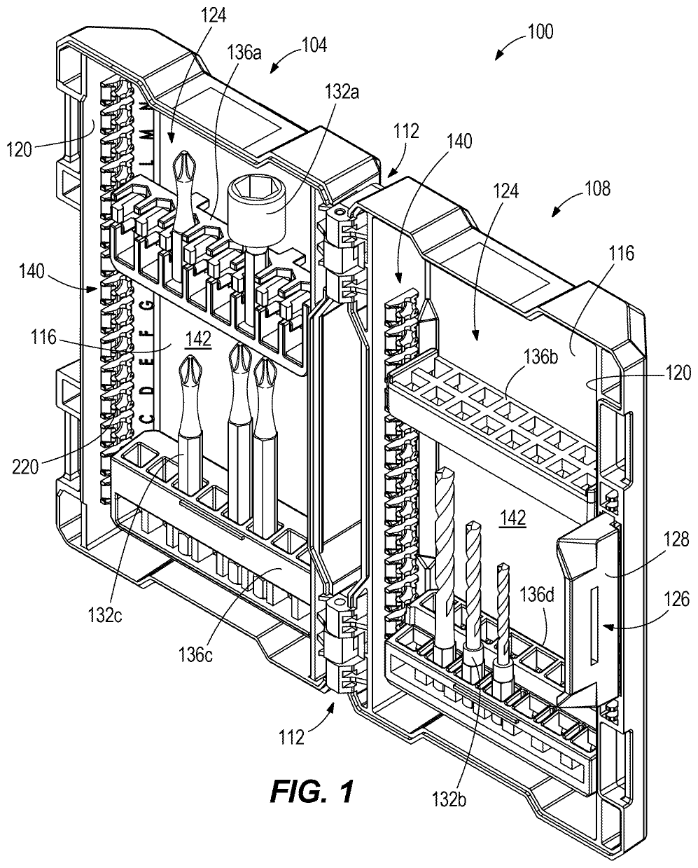

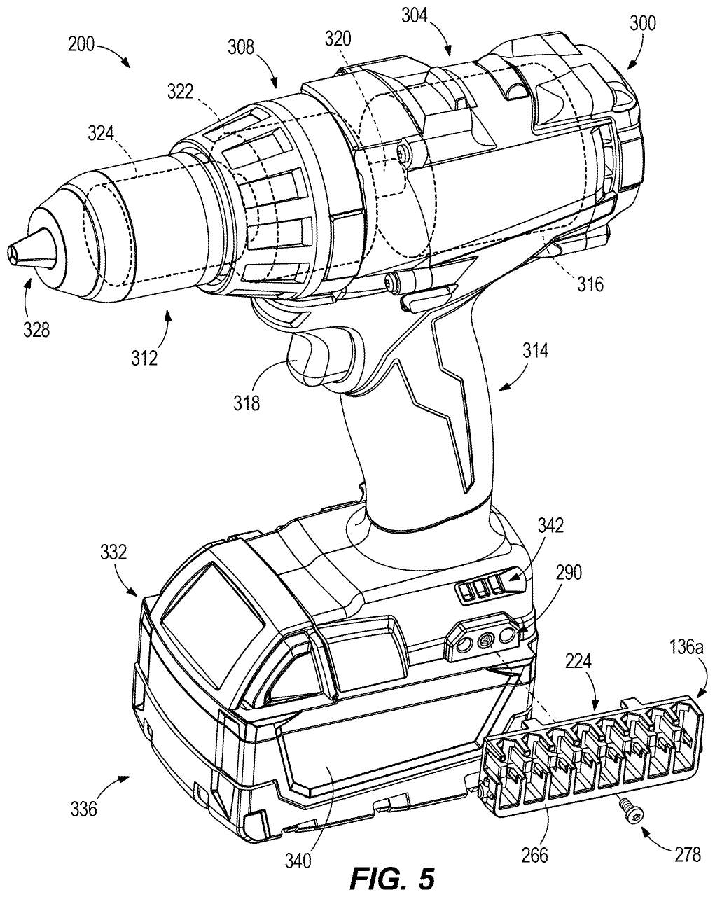

FIGS. 1 and 5 together illustrate a tool accessory storage system that includes a tool accessory case 100 (FIG. 1), a power tool 200 (FIG. 5), and a plurality of tool accessory holders 136a, 136b, 136c, 136d configured to hold one or more tool accessories 132a, 132b, 132c for use with the power tool 200. The tool accessory holders 136a-d can be alternately coupled to the tool accessory case 100 and the power tool 200.

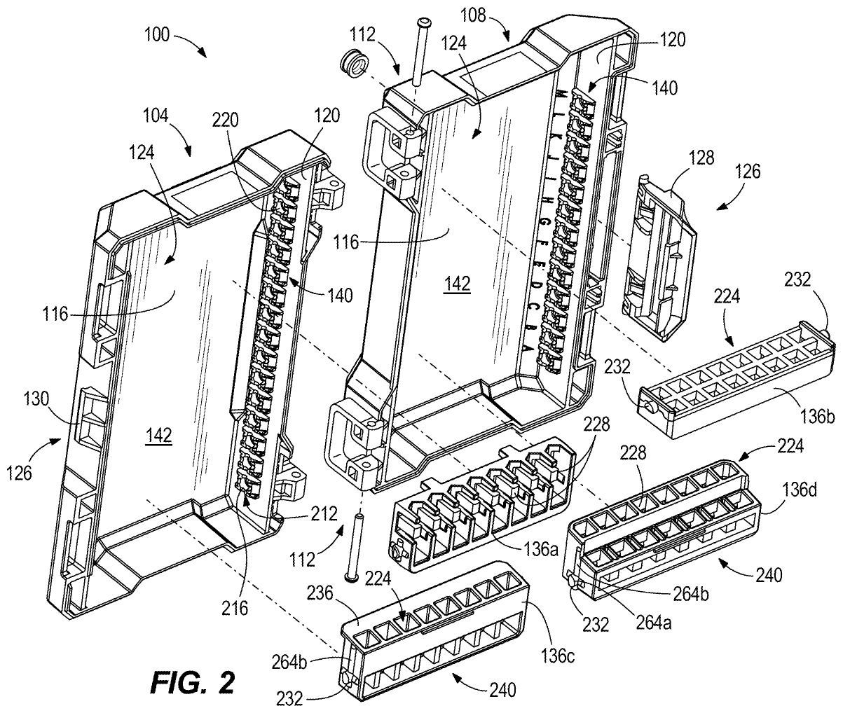

FIGS. 1 and 2 illustrate the tool accessory or bit case 100 including two housing members 104, 108 pivotally coupled together by two hinges 112. In the illustrated embodiment, the first housing member 104 is a front cover, and the second housing member 108 is a rear cover. Each of the front cover 104 and the rear cover 108 includes a base 116 and sidewalls 120 that extend from and surround the base 116. In some embodiments, the tool bit case 100 is stackable with other tool bit cases of different sizes (e.g., tool bit cases having larger or smaller footprint areas). In the illustrated embodiment, the tool bit case 100 generally has a dog bone shape.

As illustrated in FIG. 1, the front and rear covers 104, 108 are pivotable between an open position and a closed position (not shown). When in the closed position, the sidewalls 120 of both the front and rear covers 104, 108 abut each other and enclose a storage space 124. In addition, the hinges 112 define support structures that can support the tool bit case 100 on a surface, such as a table, when the tool bit case 100 is in the closed position. When in the open position, as best illustrated in FIG. 1, the sidewalls 120 of both the front and rear covers 104, 108 are moved away from each other to allow access to the storage space 124. In the illustrated embodiment, the storage space 124 is at least partially defined by an interior volume of one or both of the covers 104, 108.

The tool bit case 100 further includes a latch mechanism 126 to selectively secure the tool bit case 100 in the closed position. The illustrated latch mechanism 126 includes a latch 128 that is pivotally coupled to the rear cover 108 and engageable with a locking protrusion 130 located on the front cover 104. In other embodiments, the relative positions of the latch 128 and the protrusion 130 may be reversed. The latch 128 engages the locking protrusion 130 such that the tool bit case 100 is secured in the closed position. In contrast, the latch 128 disengages from the locking protrusion 130 such that the tool bit case 100 can be opened. The latch mechanism 126 further includes resilient portions that bias the latch 128 towards the locking protrusion 130 while in the locked position.

With specific reference to FIG. 1, the tool bit case 100 retains and organizes multiple types of tool accessories 132a-c within the storage space 124. For example, the tool bit case 100 retains various sizes of tool accessories 132a-c for use with the power tool 200 (FIG. 5) such as drill bits, driver bits, impact bits, socket bits, and the like. The tool bits 132a-c are received in tool accessory or bit holders 136a-d that are coupled to engagement features 140. In the illustrated embodiment, the tool bit holders 136a-d are pivotably (e.g., rotatably) coupled to the engagement features 140.

The engagement features 140 are located within the storage space 124 on the sidewalls 120 of the front and rear covers 104, 108. The tool bit holders 136a-d are multi-positionable relative to the covers 104, 108 to obtain different organization configurations (e.g., to support and store different sizes or types of tool bits 132a-c). In addition, the illustrated tool bit holders 136a-d are snapped into place within the tool bit case 100 so that the holders 136a-d can be removed and repositioned to achieve different configurations. As will be described in greater detail below, one or more of the accessory holders 136a-d is additionally removably couplable to the power tool 200.

The tool bit holders 136a-d, while in a storage position (FIG. 1), lay flat on an interior surface 142 of the base 116 such that the tool bit case 100 can be closed when all of the tool bit holders 136a-d are in the storage position. When the tool bit holders 136a-d are in an upright position, the tool bit holders 136a-d are rotated approximately 90 degrees to extend generally perpendicularly from the interior surface 142 of the base 116 such that the tool bit case 100 cannot be closed when at least one tool accessory holder 136c-d is in the upright position.

As best illustrated in FIG. 2, the engagement features 140 are aligned in series on each opposing sidewall 120 of the front and the rear covers 104, 108. In the illustrated embodiment, the engagement features 140 are equally spaced from each other and correspondingly align with another engagement feature 140 on the opposite sidewall 120. In some embodiments, the engagement features are not equally spaced.

Each engagement feature 140 includes a boss 212 that extends from the sidewall 120 toward the opposing sidewall 120. Each boss 212 defines an aperture 216. In the illustrated embodiment, each engagement feature 140 along one of the sidewalls 120 is identified with indicia (e.g., A-M, 1-13, etc.), which aids in aligning the tool bit holders 136a-d across the covers 104, 108. In other embodiments, the engagement features 140 may have other configurations. For example, the engagement features 140 may include projections or posts extending from the sidewalls.

As shown in FIG. 2, each boss 212 includes grooves 220 adjacent the aperture 216. The grooves 220 extend radially outward from corresponding apertures 216. In the illustrated embodiment, each boss 212 includes four grooves 220 that are circumferentially spaced at approximately 90-degree increments around the apertures 216. In addition, adjacent grooves 220 of adjacent bosses 212 are linearly aligned. In other embodiments, the bosses 212 may include less or more than four grooves 220, and/or the grooves 220 may be incremented at different angles.

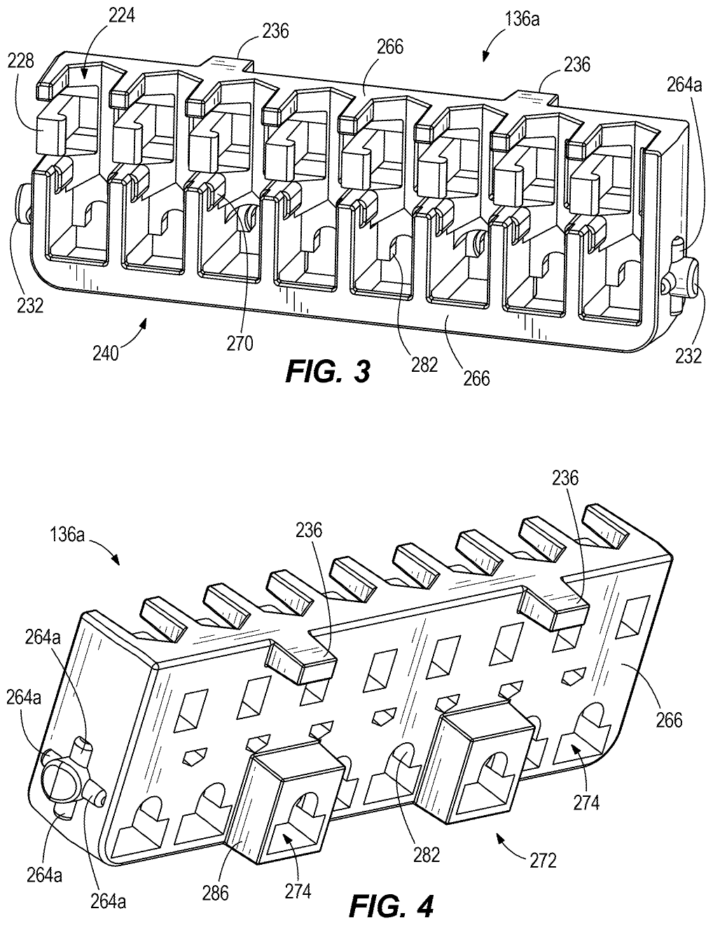

FIG. 2 further illustrates different types of the tool bit holders 136a-d that can be alternately coupled to the accessory storage case 100 and to the power tool 200. Each tool bit holder 136a-d includes one or more compartments 224. In the illustrated embodiment, each tool bit holder 136a-d includes multiple compartments 224. The compartments 224 are able to receive different tool bits 132a-c. Each compartment 224 may be discrete from one or more of the other compartments 224. Each compartment also includes a resilient finger 228 that extends from one side of the discrete compartments 224. In the illustrated embodiment of the bit holders 136a-d, as shown best in FIG. 3, the fingers 228 are cantilevered tabs. The fingers 228 engage the tool bits 132a-c to help secure the tool bits 132a-c within the tool bit holders 136a-d. In addition, each of the tool bit holders 136a-d include a first retainer 232. In the illustrated embodiment, the first retainer 232 is a projection that extends outwardly from a side surface of the tool bit holders 136a-d. The illustrated tool bit holders 136a-d include two retainer 232 extending outwardly from opposite side surfaces. In some embodiments, each tool bit holder 136a-d may only include one retainer 232. The illustrated retainers 232 are generally cylindrical in shape and retain the tool accessory holders 136a-d in the tool accessory case 100. In other embodiments, the retainers 232 may have other configurations. For example, the retainers 232 may be apertures that receive projections on the accessory storage case 100.

As shown in FIGS. 2-4, particularly in FIG. 3, the tool bit holder 136a includes one row of discrete compartments 224. In addition, the tool bit holder 136a includes two flanges 236 that inhibit over-pivoting of the tool bit holder 136a past the storage position. The tool bit holder 136a defines an open region 240 formed in a front face of the holder 136a. In the illustrated embodiment, the open region 240 extends completely through the tool bit holder 136a.

The tool bit holder 136a further includes ribs 264a adjacent each projection 232. The ribs 264a extend radially outward from the corresponding projection 232. In addition, the ribs 264a are configured to fit within the grooves 220 of the engagement features 140. As shown in FIG. 4 of the illustrated embodiment, the tool bit holder 136a includes four ribs 264a orientated at approximately 90-degrees increments.

Referring specifically to FIG. 2, the tool bit holder 136b includes two rows of discrete compartments 224. The resilient fingers (not shown) are located between adjacent discrete compartments 224 of opposing rows. In the illustrated embodiment, the tool bit holder 136b does not include ribs. However, in other embodiments, the tool bit holder 136b may include ribs 264a adjacent the projections 232, similar to the tool bit holder 136a.

The tool bit holder 136c includes one row of discrete compartments 224. In addition, the tool bit holder 136c includes ribs 264a, the flange 236, and the open region 240 similar to the tool bit holder 136a. In contrast to the tool bit holder 136a, the tool bit holder 136c includes an elongated rib 264b adjacent the projections 232. The elongated rib 264b extends at a greater length from the projections 232 than the ribs 264a. The illustrated elongated rib 264b is configured to span multiple engagement features 140 and engage multiple grooves 220 when the tool bit holder 136c is in the storage position. This arrangement helps hold the tool bit holder 136c in the storage position. In addition, the tool bit holder 136c is taller than the tool bit holder 136a to receive longer tool bits 132a-c.

The tool bit holder 136d includes two rows of discrete compartments 224. The first, or back, row is taller than the second, or front, row such that the first row is able to receive longer tool bits 132a-c than the second row. Similar to the tool bit holder 136c, the tool bit holder 136d includes the open region 240, the ribs 264a, and the elongated rib 264b adjacent the projections 232. In addition, the second row of discrete compartments 224, which is shorter than the first row, includes the resilient fingers (not shown) at an interface between the first and the second rows. The first row of discrete compartments 224 includes the resilient fingers 228 opposite the interface between the rows.

In operation, the tool bit holders 136a-d are pivotally coupled to any pair of engagement features 140 within the covers 104, 108 either in the storage position or the upright position. The projections 232 and ribs 264a-b of the tool bit holders 136a-d are received in and engage the apertures 216 and grooves 220 of the engagement features 140 to releasably secure the holders 136a-d within the case 100 and semi-rigidly retain the tool bit holders 136a-d in the storage position or the upright position.

In some instances, the tool bit holders 136a-d can receive any combination of tool bits 132a-c. When the tool bits 132a-c are inserted into the discrete compartments 224, the resilient fingers 228 engage a portion of the tool bits 132a-c such that the tool bits 132a-c are secured in the tool bit holders 136a-d until the user removes (e.g., pulls) the tool bits 132a-c from the tool bit holders 136a-d. In other words, the resilient fingers 228 provide enough force on the tool bits 132a-c, relative to the force of gravity and typical forces during transportation of the tool bit case 100, to retain the tool bits 132a-c within the tool bit holders 136a-d.

With reference to FIGS. 3 and 4, the tool bit holder 136a will be described in more detail. While some of the following features are illustrated and described with respect to the tool bit holder 136a, it should be understood that any or all of such features may be incorporated with each of the tool bit holders 136a-d. That is, the features/components of the tool bit holder 136a described herein are not necessarily exclusive to the tool bit holder 136a and are contemplated for each of the tool bit holders 136a-d.

As illustrated in FIG. 3, the multiple compartments 224 are formed in a body 266 of the tool bit holder 136a. In the illustrated embodiment, the fingers 228 extend from a rear wall of the body 266 and protrude toward the open region 240. The fingers 228 are generally positioned to contact a middle or middle-upper portion of the tool accessories 132a-c held in the tool accessory holder 136a. The body 266 further includes a stop member or tab 270 generally positioned to extend from the body 266 and contact a lower portion of the tool accessories 132a-c than the fingers 228.

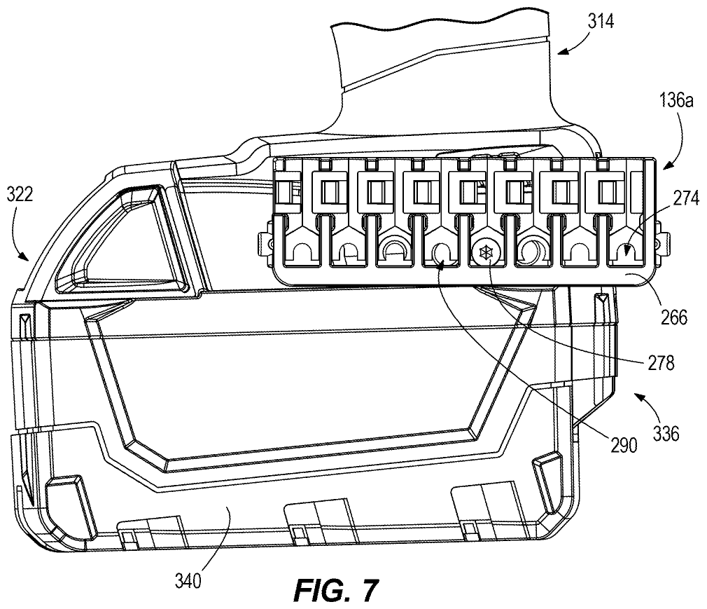

Referring now to FIGS. 3 and 4, in addition to the first retainers 232 providing a holder-to-case retainer, the tool bit holder 136a further includes a second retainer 272. The second retainer 272 provides a holder-to-power tool retainer. The illustrated second retainer 272 includes a plurality of through holes 274 extending through the body 266. As illustrated in FIGS. 5 and 7, each of the through holes 274 may be sized and shaped to receive a fastener 278. In one example construction of the body 266 and tool bit holder 136a, the fastener 278 is a threaded fastener 278 and one or more of the through holes 274 includes a bore 282 configured to receive the threaded fastener 278. The bore 282 is threaded in some embodiments. In the illustrated embodiment, the body 266 includes a boss 286 that protrudes from the body 266 and wraps or extends around at least one of the through holes 274. Providing the boss 286 around the through hole 274 increases an amount of material that receives the fastener 278. The boss 286 is also configured to contact an outer surface of the power tool 200 to help stabilize the tool bit holder 136a on the power tool 200. Although the illustrated second retainer 272 includes a plurality of through holes 274, in some embodiments, the second retainer 272 may only include one through hole 274.

Similar to how the first retainer 232 engages the tool bit case 100 to removably couple the tool bit holder 136a to the case 100, the second retainer 272 engages the power tool 200 (with the fastener 278) to removably couple the tool bit holder 136a to the power tool 200. In other words, the tool bit holder 136a includes one retainer (e.g., retainer 232) for coupling to the tool accessory case 100 and another retainer (e.g., retainer 272) for coupling to the power tool 200.

Referring now to FIGS. 5-7, the power tool 200 includes an engagement feature 290 that receives the fastener 278. As best illustrated in FIG. 5, the power tool 200 includes a housing 300 having a motor housing portion 304, a drive assembly housing portion 308, an output element housing portion 312, and a handle portion 314 graspable by a user. A motor 316 energized by actuation of a trigger 318 is supported in the motor housing portion 304 and includes an output shaft 320. A drive assembly 322 is positioned in the drive assembly housing portion 308 and is configured to be driven by the motor 316 via the output shaft 320. An output element 324 such as a hammer, anvil, camshaft, or the like is supported in the output element housing portion 312 and is driven by drive assembly 322. The output element 324 includes a receiver 328 (e.g., a chuck) that selectively receives the tool accessories 132a-c. The handle portion 314 extends from the motor housing portion 304. In the illustrated embodiment, the handle portion 314 extends generally perpendicular to the motor housing portion 304. The power tool 200 further includes a battery receptacle 332 supported by the handle portion 314. The battery receptacle 332 is located at an end of the handle portion 314 opposite from the motor housing portion 304. The battery receptacle 332 is part of a foot 336 of the power tool 200/handle portion 314. The battery receptacle 332 selectively receives a battery pack 340 to power the power tool 200.

The battery pack 340 may be a power tool battery pack 340 generally used to power a power tool, such as an electric drill, a rotary impact tool, a rotary tool, an electric saw, and the like (e.g., an 18 volt rechargeable battery pack, or an M18/M12 REDLITHIUM battery pack sold by Milwaukee Electric Tool Corporation). The battery pack 340 may include lithium ion (Li-ion) cells or packs of a different chemistry (e.g., nickel-cadmium (NiCa or NiCad), nickel-hydride, and the like). The battery pack 340 or power tool 200 may further include an indicator 342 to display the current state of charge of the battery pack and/or other characteristics of the battery pack.

In the illustrated embodiment, the fastener 278 is threadably received in the engagement feature 290 with at least a portion of the tool bit holder 136a positioned between a head of the fastener 278 and the power tool 200. In the illustrated embodiment, the engagement feature 290 is a receiver, such as a threaded bore, that receives the fastener 278. In other embodiments, the engagement feature 290 may have other configurations. For example, the engagement feature 290 may include a projection, post, or threaded stud that is received in an aperture of the tool bit holder 136a. In some embodiments, one or more fasteners may extend from the body 266 without being received in the through hole 274. For example, a hook or tab may extend from the body 266. In other embodiments, the fastener is rigidly attached to the body 266 such that the entire tool bit holder 136a may be rotated to thread the fastener into the receiver 290 of the power tool 200. In the illustrated embodiment, the receiver 290 is positioned adjacent the foot 336 of the power tool 200 but could be positioned elsewhere, such as forwardly on the battery receptacle 332, on the battery pack 340, or on another part of the housing 300.

In yet another embodiment, the fastener of the holder-to-power tool retainer includes a magnet, and the receiver 290 of the power tool 200 includes an oppositely polarized magnet. In still another embodiment, the receiver of the power tool 200 includes one or more recessed regions that receive the boss 286, the flange 236, and/or an entire outer periphery of the tool bit holder 136a. In an even further embodiment, the power tool 200 includes a retainer arrangement similar to the engagement features 140 of the tool bit case 100 such that the projections 232 and ribs 264a of tool bit holder 136a engage a complimentary retainer structure on the power tool 200. In such further embodiments, the holder-to-power tool retainer and the holder-to-case retainer are one in the same.

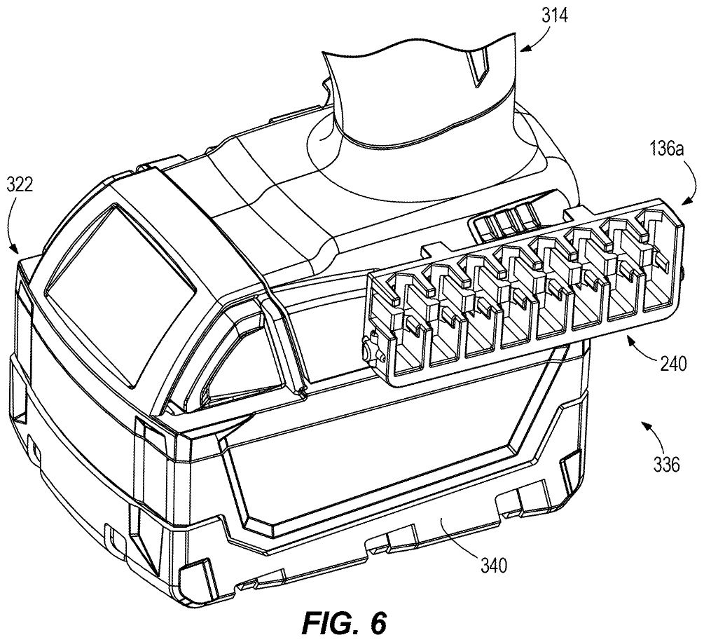

In operation of the tool bit holder 136a, the tool bit holder 136a can be selectively removed from the tool accessory case 100 and, as shown in FIGS. 6 and 7, coupled to the power tool 200, or the tool bit holder 136a can be removed from the power tool 200 and selectively coupled to the tool accessory case 100. As illustrated in FIG. 7, the threaded fastener 278 is received in a central or generally middle through hole 274 on the tool bit holder 136a and fastened to the receiver 290 of the power tool 200, which, in some embodiments, includes a threaded bore. It should be understood that any of the through holes 274 may accommodate the fastener 278 such that the tool bit holder 136a is attachable to the power tool 200 in a more forwardly or rearwardly position depending on a user's desire or preference.

Although the disclosure has been described in detail with reference to certain preferred embodiments, variations and modifications exist within the scope and spirit of one or more independent aspects of the disclosure as described.

Various features and advantages of the disclosure are set forth in the claims.

1. A tool accessory holder for use with a tool accessory case and configured to couple to a power tool, the tool accessory holder comprising:
a body configured to hold one or more tool accessories for use with the power tool, the body configured to be selectively received in the tool accessory case;
a first retainer coupled to the body and configured to couple the tool accessory holder to the tool accessory case; and
a second retainer coupled to the body and configured to couple the tool accessory holder to the power tool;
wherein the tool accessory holder is removable from the tool accessory case and couplable to the power tool.

2. The tool accessory holder of claim 1, wherein the first retainer is a projection extending from a side of the body.

3. The tool accessory holder of claim 2, wherein the projection is configured to be releasably coupled to an engagement feature located on a sidewall of the tool accessory case.

4. The tool accessory holder of claim 2, wherein the projection is a first projection, and wherein the first retainer also includes a second projection extending from a side of the body opposite the first projection.

5. The tool accessory holder of claim 1, wherein the second retainer is a bore formed in the body, and wherein the bore receives a threaded fastener to couple the tool accessory holder to the power tool.

6. The tool accessory holder of claim 5, wherein the bore extends through a front and a back of the body.

7. The tool accessory holder of claim 1, wherein the tool accessory holder is rotatable relative to tool accessory case while coupled to the tool accessory case.

8. The tool accessory holder of claim 1, wherein the tool accessory holder is moveable relative the tool accessory case between a storage position and an upright position while coupled to the tool accessory case.

9. The tool accessory holder of claim 1, wherein the body defines a plurality of compartments, wherein each of the plurality of compartments is configured to receive one of the one or more tool accessories for use with the power tool.

10. The tool accessory holder of claim 9, wherein the plurality of compartments is arranged in a row along a length of the body.

11. The tool accessory holder of claim 1, wherein the one or more tool accessories for use with the power tool include one or more selected from a group consisting of a drill bit, a driver bit, an impact bit, and a socket bit.

12. A tool system comprising:
a tool accessory storage case including
one or more housing members at least partially defining a storage area, and
an engagement feature located on the one or more housing members adjacent the storage area;
a power tool including
a housing,
a motor positioned in the housing,
a drive assembly supported by the housing and coupled to the motor, and
an output element coupled to the drive assembly; and
a tool accessory holder configured to hold at least one tool accessory for use with the power tool, the tool accessory holder alternately couplable to the tool accessory storage case and to the power tool.

13. The tool system of claim 12, wherein the tool accessory holder includes a first retainer couplable with the engagement feature of the tool accessory storage case, and wherein the tool accessory holder includes a second retainer couplable with a retainer of the power tool.

14. The tool system of claim 13, wherein the first retainer is a projection, and wherein the second retainer is a bore that receives a threaded fastener.

15. The tool system of claim 12, wherein the housing of the power tool includes a battery receptacle defining a foot of the power tool, and wherein the tool accessory holder couples to the foot.

16. The tool system of claim 15, wherein the housing also includes a motor housing portion that receives the motor and a handle portion extending from the motor housing portion, and wherein the battery receptacle is coupled to an end of the handle portion opposite from the motor housing portion.

17. The tool system of claim 12, wherein the engagement feature is one of a plurality of engagement features located on the one or more housing members, and wherein the tool accessory holder is couplable to the plurality of engagement features in different positions.

18. A tool accessory storage system comprising:
a tool accessory case including one or more housing members at least partially defining a storage area, and an engagement feature located on the one or more housing members adjacent the storage area; and
a tool accessory holder including a body configured to hold one or more tool accessories for use with a power tool, and a retainer coupled to the body;
wherein the retainer is selectively engageable with the engagement feature to removably couple the tool accessory holder to the tool accessory case; and
wherein the tool accessory holder is removable from the tool accessory case and configured to couple to the power tool.

19. The tool accessory storage system of claim 18, wherein the retainer is a projection extending from a side of the body, and wherein the engagement feature is a receiver formed in a sidewall of the one or more housing members.

20. The tool accessory storage system of claim 19, wherein the tool accessory holder also includes a bore formed in the body, and wherein the bore receives a threaded fastener to couple the tool accessory holder to the power tool.
